(19) United States
(12) Patent Application Publication
(10) Pub. No.: US 2008/0066281 A1
(43) Pub. Date: Mar. 20, 2008

(54) Linkage Bushing Installation Pliers

(75) Inventors: Robert Allen, Sacramento, CA (US); Wen-Lung Chang, Burlingame, CA (US)

Correspondence Address: DAVID E. NEWHOUSE, ESQ, 477 NINTH AVE. 112, SAN MATEO, CA, 94402-1858, US

(73) Assignee: Wen-Lung Chang, Burlingame, CA (US)

(21) Appl. No.: 11/533,757

(22) Filed: Sep. 20, 2006

(51) Int. Cl. B23P 19/04

(52) U.S. Cl. 29/268

(57) ABSTRACT

A pair of linkage bushing installation pliers includes two pivotally coupled, elongated handles with opposing clamping jaws, one presenting an annular clamping anvil for engagement around a receiving aperture on one side of a lever, the other presenting a seating anvil having a perpendicularly extending stool for coaxially forcing a linkage bushing, coaxially placed around the stool, into and through the receiving aperture from the opposite side of the lever.

### BACKGROUND OF THE INVENTION

1. Field of the Invention

The invention is a pair of pliers for installing resilient linkage bushings anchored by adjacent, annular circumferential shoulders within linkage apertures of transmission shift levers.

2. Description of the Prior Art

Machine transmissions for vehicles and the like, typically have one or more exterior shift levers rotating/pivoting shafts that shift or switch internal mechanical transmission components for altering output rotational power from a motor delivered to an output drive shaft. Such shift levers are rotated/pivoted by linkage arms, rods and the like that connect between the manual controls of the machine and the transmission shift levers. Typically an ‘L-foot’ at the end of a linkage arm is journaled through a hole or aperture near the free end of the shift lever to allow relative rotation between linkage arm and the shift lever as the linkage arm is translated for rotating/pivoting the shift lever. Resilient polymer linkage bushings composed of for example, Nylon®, are frequently installed and anchored within the linkage aperture of the shift lever for snugly receiving the linkage arm ‘L-foot’ to mitigate vibration and destructive wear at the couple.

Replacing such linkage bushings in transmission shift leaver apertures is a major headache for mechanics because such transmission shift levers are typically not easily accessed. Compounding the frustration of difficult access is the fact that such linkage bushings must be press fit into and through the shift lever aperture requiring essentially coaxial alignment of the bushing, the shift lever aperture and the force applied for popping the bushing through the aperture.

To explain, such linkage bushings provide a inner cylindrical a sleeve for snugly receiving the ‘L-foot of the linkage arm and have adjacent exterior circumferential anchoring shoulders greater in diameter than the shift lever aperture that provide an annular mounting channel dimensioned and shaped for snugly and resiliently anchoring the bushing between the lever sides around the shift lever aperture. Accordingly, to install the bushing it must be pressed into the shift lever aperture, forcing or pushing one of its larger anchoring shoulders through the smaller diameter aperture. If either the bushing or the force applied at the end of the bushing urging it into the bushing is not aligned with the axis of the aperture, the bushing can plastically deform lessening its effectiveness. Ideally, as the larger diameter exterior shoulder of the is forced into and through the smaller diameter shift lever aperture, the bushing elastically deforms collapsing circumferentially until the inserted anchoring shoulder pops out other end of the aperture.

Historically the jaws of hand pliers have been modified for performing a multitude of different mechanical manipulations requiring application of opposing, compressive or tensile forces including: repairing radiator tubes [U.S. Pat. No. 1,442,486, Looke]; opening, compressing and placing snap rings [U.S. Pat. No. 3,990,137 Kulba et al]; removing bases of broken light bulbs from corroded sockets [U.S. Pat. No. 4,554,848 Galletto]; closing hemi-cylindrical bushings around electrical conduits and then inserting the so closed bushings into chassis apertures [U.S. Pat. No. 4,870,876, Rodriquez]; riveting [U.S. Pat. No. 6,085,400, Yang-Ting Liu]; punching holes [U.S. Pat. No. 6,282,796 Kun-Meng Lin]; servicing 1911 pistols [U.S. Pat. No. 6,904,634, G. H. Smith]; and sharpening fish hooks [U.S. Pat. No. 7,039,973 Lehmann].

### SUMMARY OF THE INVENTION

An invented pair of linkage bushing installation pliers includes two pivotally coupled, elongated handles with opposing clamping jaws, one presenting an annular clamping anvil for engagement around a receiving aperture on one side of a lever, the other presenting a seating anvil having a perpendicularly extending stool for coaxially forcing a linkage bushing, coaxially placed around the stool, into and through the receiving aperture from the opposite side of the lever.

In the preferred embodiment, the seating anvil surface is concave and angled such that when popping the bushing coaxially placed around the stool into and through the receiving aperture, the applied clamping force is essentially coaxially aligned with the axis of the aperture. The stool extends more than half way through toward the bushing end beyond any exterior annular anchoring shoulders and the stool top is sized to loosely fit within the bushing sleeve for holding and orienting the linkage bushing on the seating anvil as the invented pliers are manually manipulated into a position for inserting the bushing into and through a lever aperture. The stool pedestal is diametrically sized sufficiently smaller than the surrounding bushing sleeve for allowing the bushing to elastically deform collapsing circumferentially as the exterior annular anchoring shoulder of the bushing next to the receiving aperture is forced or popped through the aperture by the clamping force manually exerted by the pliers.

### BRIEF DESCRIPTION OF THE FIGURES

FIG. 1 is a side elevation outline view of an exemplary 220 Chassis Mercedes Benz transmission illustrating typical shifter linkage pivoting locations exterior the transmission casing.

FIG. 2 is a perspective rendering illustrating the dimensional relationship of a typical transmission linkage bushing and a receiving aperture at the end of a transmission lever.

FIG. 3 is a perspective illustration showing details of the invented linkage bushing installation pliers.

FIG. 4 is a side elevation view of the invented linkage bushing installation pliers.

FIG. 5 is a bottom elevation view of the invented linkage bushing installation pliers showing the relationship of it annular anvil, the top of the stool extending up from the lower.

FIG. 6 is a partial side elevation view of the invented linkage bushing installation pliers popping a shift linkage bushing through the receiving aperture at the end of a shift lever.

### DESCRIPTION OF PREFERRED AND EXEMPLARY EMBODIMENTS

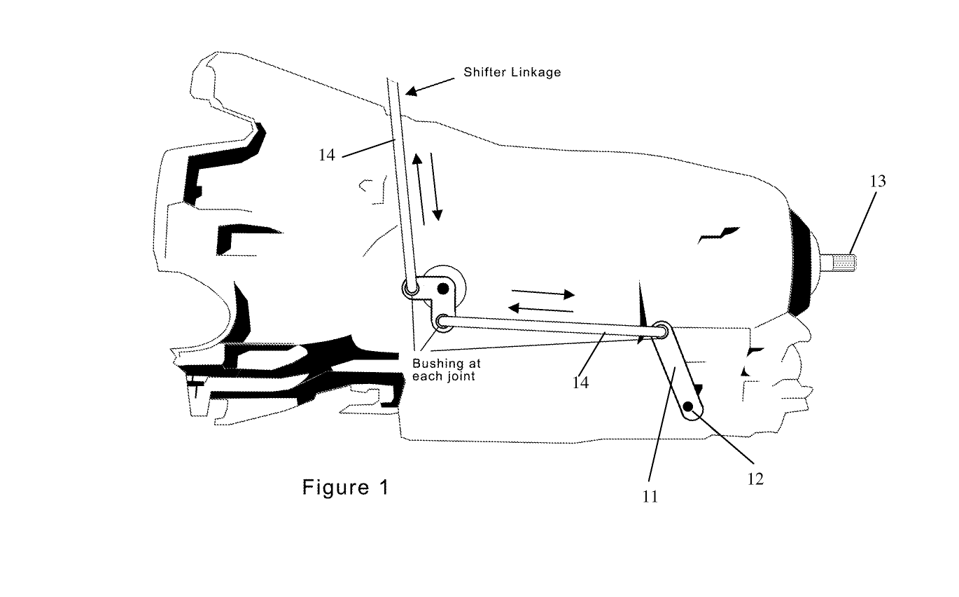

Looking at FIG. 1 many vehicle transmissions 10 have exterior shift levers 11 rotating/pivoting shafts 12 that shift or switch internal mechanical transmission components (not shown) for altering output rotational power from a motor delivered to an output drive shaft 13.

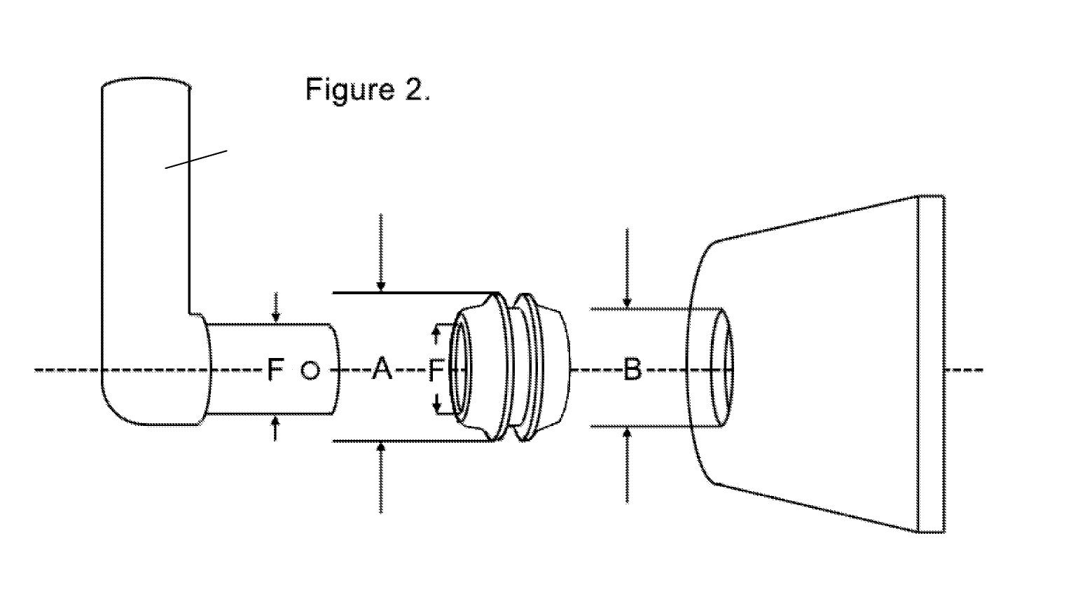

Looking at FIG. 2, shift levers 11 are rotated/pivoted by linkage arms 14 that connect between the manual controls (not shown) of the machine and the shift lever 11. Typically an ‘L-foot’ 16 at the end of a linkage arm 14 is journaled through a hole or linkage aperture 17 near the free end 18 of the shift lever 11 to allow relative rotation between linkage arm 14 and the shift lever 11 as the linkage arm 14 is translated for rotating/pivoting the shift lever 11. Resilient polymer linkage bushings 19 composed of, for example, Nylon®, are installed and anchored within the linkage aperture 17 of the shift lever 11 for snugly receiving the linkage arm ‘L-foot’ 16 mitigating vibration and destructive wear at the couple.

To gain access to a shift lever 11 for replacement of a worn linkage bushing 19, in most instances, requires a lift to raise the vehicle to allow access to its transmission 10 from underneath. In other instances the vehicle may have removable bottom vehicle body panels allowing access above the transmission 10. In either instance typically, the shift lever(s) 11 are not conveniently located for easy replacement of a linkage bushing 19.

To explain, as shown in FIG. 2, the linkage bushing 19 provides a sleeve 21 of a diameter F slightly greater than that F of the ‘L-foot’ 16 for snugly receiving the ‘L-foot’ 16 and has a pair of parallel annular anchor shoulders 22 spaced t apart around its midsection slightly smaller than the thickness t of the shift lever 11 around the linkage aperture 17. The diameter A of the anchoring shoulders 22 is greater than the diameter B of the linkage aperture 17. Typically, the exterior cylindrical diameter 23 of the linkage bushing 19 conically increases from its respective ends from a diameter A of, or very slightly smaller than the linkage aperture 17 to diameter B of the anchor shoulders 22.

Accordingly after removal of a worn linkage bushing, one end of the new linkage bushing 19 must be positioned, coaxially nested in the linkage aperture 17 at the end 18 of the shift lever 11 whereupon the bushing 19 can then be forced into the aperture 17 until the annular anchoring shoulder 22 proximate the aperture 17 pops out the other side or end of the aperture. The problem is that as the bushing 19 is being pushed into the linkage aperture 17, it must not be plastically or permanently deformed.

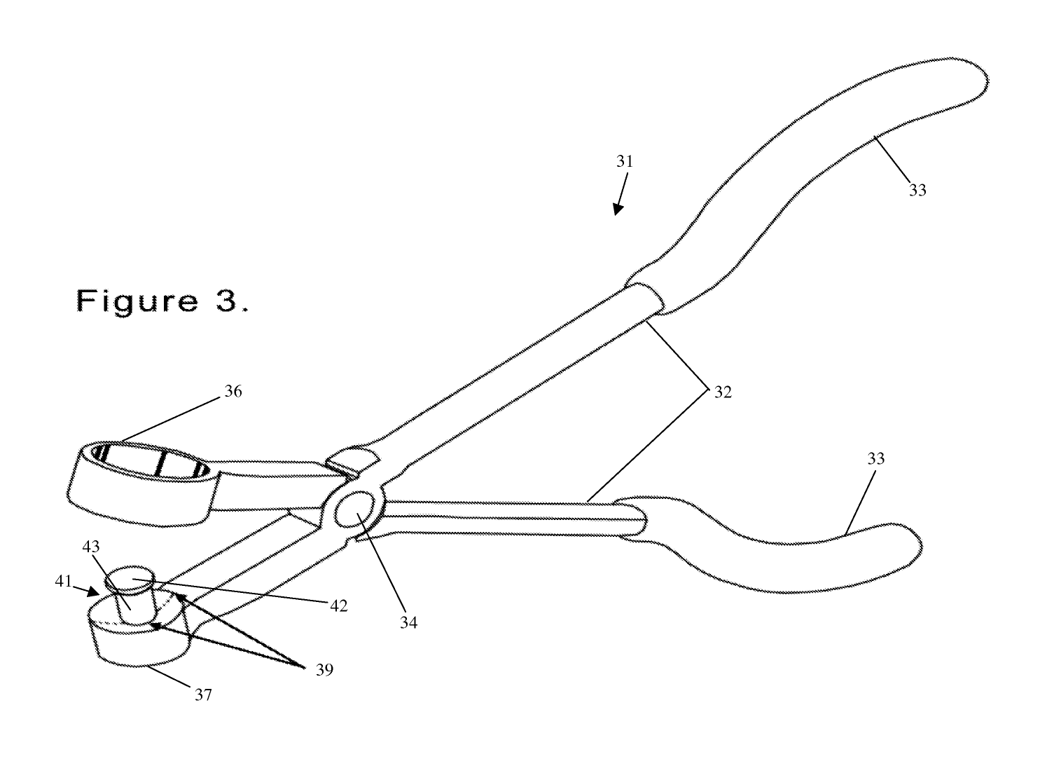

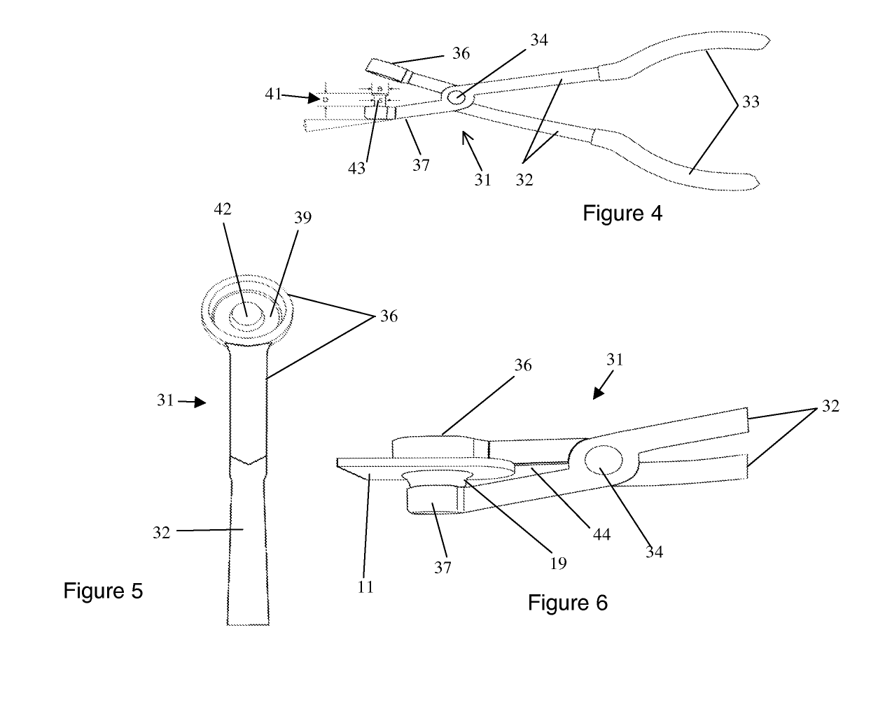

Turning now to FIGS. 3, 4, 5 & 6, the invented linkage bushing installation pliers 31 has two pivotally coupled, plier members with elongated handles 32 with looping handgrips 33 on one side of the pivoting couple 34 and opposing force clamping jaws 36 & 37 on the other side of the pivoting couple 34. Clamping jaw 36 is an annular anvil presenting a flat face 38 for engagement around a linkage aperture 17 on one side of a shift lever 11. Opposing clamping jaw 37 presents a concave seating anvil 39 with a coaxial, perpendicularly extending stool 41 for receiving, holding and orienting the linkage bushing 19 on the seating anvil, as the pliers are manually manipulated into a position for manually applying a clamping force for inserting the bushing into the receiving linkage aperture 17 from the opposite side of the shift lever 11.

As shown in FIGS. 3 & 4, the seating anvil 39 and stool are angled with respect to a radial line plane extending from the pivot couple 34 such that when popping a bushing 19 into a receiving aperture 17, the applied clamping force will be essentially coaxially aligned with the axis of the aperture 17. The stool extends more than halfway through the linkage bushing sleeve 21 beyond the annular anchor shoulder 22 next to the aperture 17. The stool top 42 is sized to loosely fit within the bushing sleeve 21 for holding and orienting the linkage bushing 19 as the invented pliers 41 are manually manipulated for insertion positioning the distal end of the so-mounted bushing 19 nested within the aperture 17. Once properly positioned, clamping force is manually applied via the elongated handles 32 across the pivot couple 34 to the clamping jaws 36 & 37 to force the bushing 19 into and through the linkage aperture 17. The stool pedestal 43 is diametrically sized sufficiently smaller than the surrounding bushing sleeve 21 for allowing the bushing 19 to elastically deform collapsing circumferentially as the annular anchor shoulder 22 of the bushing 19 next to the receiving aperture 17 is forced or popped through the aperture 17 by the clamping force manually applied by the pliers 41.

Looking at FIGS. 2 & 5, the skilled tool designer should recognize that the throat 44 of the invented linkage bushing installation pliers 43 should be deep enough to accommodate the distance from the side of the shift lever 11 to the linkage aperture 17, and as well, provide enough space 46 between the clamping jaws 36 and 37 from the pivot couple 34 to accommodate the thickness of the shift lever body surrounding the linkage aperture 17.

While the invented linkage bushing installation pliers have been disclosed and described in context of installation difficulties confronting mechanics replacing worn linkage bushing at the couple of the linkage arm and shift lever(s) of a vehicle transmission, it should be appreciated that the invented pliers may be used for installing similar bushings in similar coupling apertures in any mechanical system. Further, many modifications and variations of the essential elements of the invented linkage bushing installation pliers can be made both with respect to the particular tool described and other analogous tools which, while not described above, do fall within the spirit and scope of the invention as set forth in the appended claims.

I claim:

1. Bushing installation pliers comprising a pair of plier members having a pivoting couple between elongated handles and opposing clamping jaws, one presenting an annular clamping anvil for engagement around one end of a bushing aperture through a plate structure on one side, the other presenting a seating anvil having a coaxial, perpendicularly extending stool for receiving, holding and orienting a cylindrical sleeve bushing seated on the seating anvil while the pliers are manually manipulating to a position for inserting the seated sleeve bushing nesting its extending end coaxially within the bushing aperture from an opposite side of the plate structure, whereby, manually closing the elongated handles together applies a clamping force essentially aligned with the axis of the bushing aperture for forcing the cylindrical sleeve bushing into the bushing aperture through the structural plate.

2. The bushing installation pliers of claim 1 wherein the stool extending from the seating anvil has a stool top diametrically dimensioned for loose engagement within the received cylindrical sleeve bushing placed around the stool seated on the seating anvil and a length dimensioned to extend more than half way through the sleeve bushing.

3. The bushing installation pliers of claim 2 wherein the stool extending from the seating anvil has a pedestal diameter less than the stool top for allowing circumferential elastic circumferential deformation of the cylindrical sleeve bushing as it is forced into and anchored within the bushing aperture.

4. The bushing installation pliers of claim 1, 2 or 3 wherein the annular clamping anvil for engagement around a bushing aperture through the plate structure has an inside diametric dimension greater than outside diametric dimensions of the cylindrical sleeve bushing at its ends.

5. The bushing installation pliers of claim 1 or 3 wherein the coaxial, perpendicularly extending stool for receiving, holding and orienting the cylindrical sleeve bushing extends from a concave seating anvil angled relative to a radial plane extending from the pivoting couple between the plier members for maintaining alignment of the clamping force applied to the seated cylindrical sleeve bushing essentially coaxial with the bushing aperture as the cylindrical sleeve bushing is pushed in the aperture to an anchor position within the aperture, the cylindrical sleeve bushing having an adjacent pair of spaced apart, larger diameter, exterior annular shoulders defining an exterior surface channel for receiving and sandwiching the plate structure around the aperture for anchoring the sleeve bushing in place within the aperture at the anchor position.

6. The bushing installation pliers of claim 5 wherein:
(i) the bushing aperture has a diameter from 11 mm to 13 mm;
(ii) the cylindrical sleeve bushing has an inside diameter from 9 mm to 11 mm, a length from 13 mm to 16 mm, exterior annular shoulders from 16 mm to 20 mm, and outside end diameters from 12 mm to 14 mm;
(iii) the stool extends above the anvil seating surface from 6 to 15 millimeters, has a pedestal diameter ranging from 7.5 mm to 8.5 mm, a stool top diameter ranging from 8.5 mm to 10 mm; and
(iv) the seating anvil is angled from 5 degrees to 12 degrees above the radial plane extending from the pivoting couple between the plier members.
